(19) United States
(12) Patent Application Publication
(10) Pub. No.: US 2013/0050440 A1
(43) Pub. Date: Feb. 28, 2013

(54) VIDEO PROCESSING APPARATUS AND VIDEO PROCESSING METHOD

(71) Applicants: Osamu KASENO, Tokyo (JP); Shinobu OKITSU, Fukaya-shi (JP)

(72) Inventors: Osamu KASENO, Tokyo (JP); Shinobu OKITSU, Fukaya-shi (JP)

(73) Assignee: KABUSHIKI KAISHA TOSHIBA, Tokyo (JP)

(21) Appl. No.: 13/398,572

(22) Filed: Feb. 16, 2012

(30) Foreign Application Priority Data
Aug. 31, 2011 (JP) 2011-189469

(51) Int. Cl. H04N 13/04

(52) U.S. Cl. 348/51; 348/E13.075

(57) ABSTRACT

According to one embodiment, a video processing apparatus includes a viewer detector, and a viewing area information calculator. The viewer detector is configured to detect the number and a position of one or a plurality of viewers using an image captured by a camera. The viewing area information calculator is configured to calculate a control parameter so as to set a viewing area, in which a plurality of parallax images displayed on a display are viewed as a stereoscopic image, according to the number and the position of the viewers. The viewing area controller is configured to set the viewing area according to the control parameter.

### CROSS REFERENCE TO RELATED APPLICATIONS

This application is based upon and claims the benefit of priority from the prior Japanese Patent Application No. 2011-189469, filed on Aug. 31, 2011; the entire contents of which are incorporated herein by reference.

### FIELD

Embodiments described herein relate generally to a video processing apparatus and a video processing method

### BACKGROUND

In recent years, a stereoscopic video display apparatus (so-called autostereoscopic television) has been widely used. A viewer can see the video displayed on the autostereoscopic television stereoscopically without using special glasses. This stereoscopic video display apparatus displays a plurality of images with different viewpoints. Then, the output directions of light rays of those images are controlled by, for example, a parallax barrier, a lenticular lens or the like, and guided to both eyes of the viewer. When a viewer's position is appropriate, the viewer sees different parallax images respectively with the right and left eyes, thereby recognizing the video as stereoscopic video.

However, there has been a problem with the autostereoscopic television in that video cannot be stereoscopically viewed depending on the viewer's position.

### BRIEF DESCRIPTION OF THE DRAWINGS

FIG. 1 is an external view of a video display apparatus 100 having the viewing area control function.

FIG. 2 is a block diagram showing a schematic configuration thereof.

FIGS. 3A to 3C are views of part of each of the liquid crystal panel 1 and the lenticular lens 2 seen from above.

FIGS. 4A to 4E are views showing an example of the technique for calculating viewing area information.

FIG. 5 is a flowchart showing an example of processing operations of the controller 10 of the video display apparatus 100 according to the first embodiment.

FIG. 6 is a block diagram showing a schematic configuration of a video display apparatus 100a according to the second embodiment.

FIG. 7 is a flowchart showing an example of processing operations of the controller 10a of the video display apparatus 100a according to the second embodiment.

FIGS. 8A to 8C are a view showing a specific example of viewing area setting according to the present embodiment.

FIGS. 9A to 9D are a view explaining an example where priorities are set based on viewing time.

FIG. 10 is a view showing an example of the priority table.

FIGS. 11A to 11D are view showings the example where priorities are set based on the priority table.

FIGS. 12A and 12B are diagrams of examples for showing the relationship between the viewers and the priority thereof.

FIG. 13 is a block diagram showing a schematic configuration of a video display apparatus 100′ as a modification of FIG. 2.

### DETAILED DESCRIPTION

In general, according to one embodiment, a video processing apparatus includes a viewer detector, and a viewing area information calculator. The viewer detector is configured to detect the number and a position of one or a plurality of viewers using an image captured by a camera. The viewing area information calculator is configured to calculate a control parameter so as to set a viewing area, in which a plurality of parallax images displayed on a display are viewed as a stereoscopic image, according to the number and the position of the viewers. The viewing area controller is configured to set the viewing area according to the control parameter.

Embodiments will now be explained with reference to the accompanying drawings.

### First Embodiment

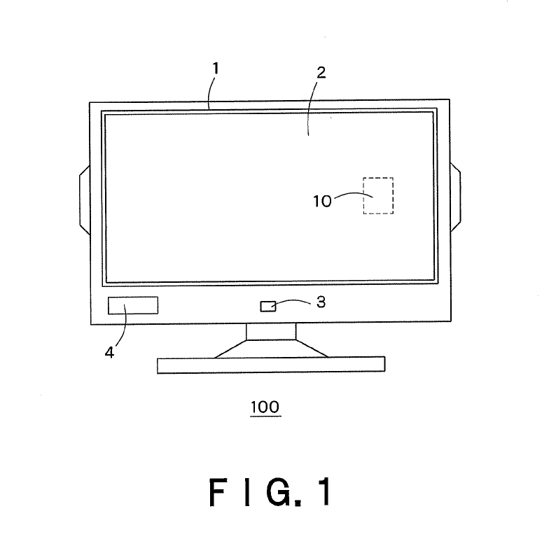

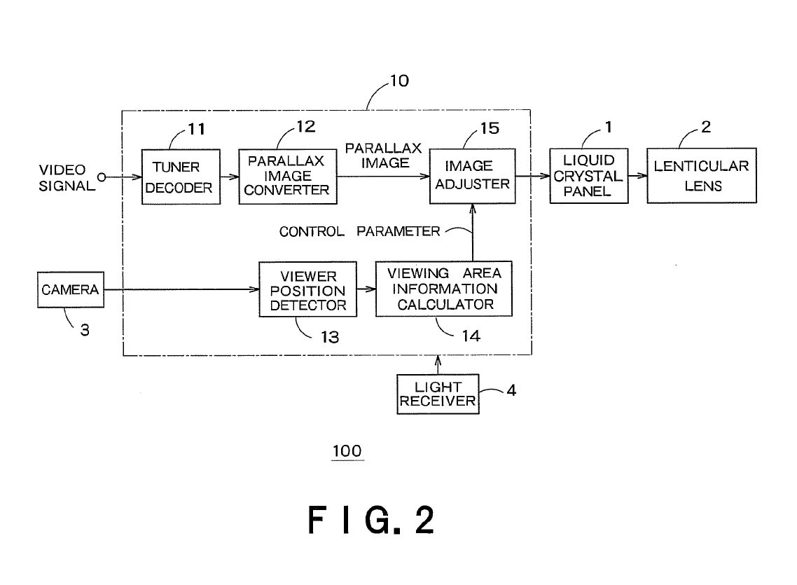

FIG. 1 is an external view of a video display apparatus 100 having the viewing area control function, and FIG. 2 is a block diagram showing a schematic configuration thereof. The video display apparatus 100 has a liquid crystal panel 1, a lenticular lens 2, a camera 3, a light receiver 4 and a controller 10.

The liquid crystal panel (display) 1 is, for example, a 55-inch size panel, where 11520 (=1280*9) pixels are arranged in a horizontal direction and 720 pixels are arranged in a vertical direction. Further, three sub-pixels, namely an R sub-pixel, a G sub-pixel and a B sub-pixel are formed in the vertical direction inside each pixel. The liquid crystal panel 1 is irradiated with light from a backlight (not shown) provided on a back surface thereof. Each pixel allows passage of light with a luminance depending on a parallax image signal (described later) provided from the controller 10.

The lenticular lens (apertural area controller) 2 has a plurality of convex portions arranged along the horizontal direction of the liquid crystal panel 1, and the number thereof is one ninth of the number of pixels in the horizontal direction of the liquid crystal panel 1. Then, the lenticular lens 2 is attached on the surface of the liquid crystal panel 1 such that one convex portion corresponds to nine pixels arranged in the horizontal direction. The light having passed through each pixel is output from the vicinity of the top of the convex portion in a particular direction with directivity.

The liquid crystal panel 1 of the present embodiment is capable of displaying stereoscopic video by a multi-parallax system (integral imaging system) with not less than three parallaxes or a two-parallax system, and other than those, it is also capable of displaying normal two-dimensional video.

In the following description, an example will be explained where nine pixels are provided corresponding to each convex portion of the lenticular lens 2 so that a multi-parallax system with nine parallaxes can be adopted. In the multi-parallax system, first to ninth parallax images are respectively displayed in the nine pixels corresponding to each convex portion. The first to ninth parallax images are images in which an object is viewed respectively from nine viewpoints arrayed along the horizontal direction of the liquid crystal panel 1. The viewer can respectively view one parallax image among the first to ninth parallax images with the left eye and another one parallax image with the right eye via the lenticular lens 2, so as to stereoscopically view the video. According to the multi-parallax system, as the number of the parallax is increased, the viewing area can be wider. The viewing area refers to an area in which video can be stereoscopically viewed when the liquid crystal panel 1 is viewed from its front.

On the other hand, in the two-parallax system, parallax images for a right eye are displayed in four pixels and parallax images for a left eye are displayed in the other five pixels among the nine pixels corresponding to each convex portion. The parallax images for a left eye and a right eye are images obtained by viewing the object from a left-side viewpoint and a right-side viewpoint respectively among the two viewpoints arrayed in the horizontal direction. The viewer can view the parallax image for a left eye with the left eye and the parallax image for a right eye with the right eye via the lenticular lens 2, so as to stereoscopically view the video. According to the two-parallax system, a three-dimensional appearance of displayed video is easier to obtain than in the multi-parallax system, but a viewing area is narrower than that in the multi-parallax system.

It is to be noted that the liquid crystal panel 1 can also display a two-dimensional image by display an identical image in the nine pixels corresponding to each convex portion.

Further, in the present embodiment, the viewing area is made variably controllable according to a relative positional relation between the convex portion of the lenticular lens 2 and a displayed parallax image, namely how the parallax image is to be displayed in the nine pixels corresponding to each convex portion. Hereinafter, the control of the viewing area will be described by taking the multi-parallax system as an example.

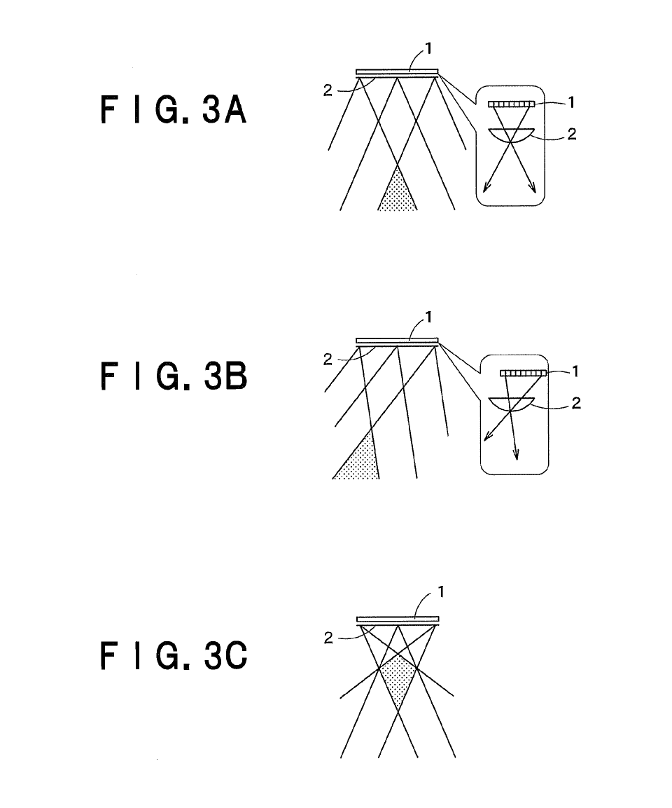

FIG. 3 is a view of part of each of the liquid crystal panel 1 and the lenticular lens 2 seen from above. A shaded area in the figure indicates a viewing area, and video can be viewed stereoscopically by viewing the liquid crystal panel 1 from the viewing area. The other areas are areas where a reverse view or a crosstalk is generated, and it is difficult to view the video stereoscopically therefrom.

FIG. 3 shows a state where the viewing area changes depending on a relative positional relation between the liquid crystal panel 1 and the lenticular lens 2, more specifically, a distance between the liquid crystal panel 1 and the lenticular lens 2 or a horizontal shift amount between the liquid crystal panel 1 and the lenticular lens 2.

In practice, because the lenticular lens 2 is highly accurately positioned and attached on the liquid crystal panel 1, it is difficult to physically change the relative position between the liquid crystal panel 1 and the lenticular lens 2.

Accordingly, in the present embodiment, display positions of the first to ninth parallax images displayed in the respective pixels of the liquid crystal panel 1 are shifted, to apparently change the relative positional relation between the liquid crystal panel 1 and the lenticular lens 2 so as to adjust the viewing area.

For example, as compared with the case of the first to ninth parallax images being respectively displayed in the nine pixels corresponding to each convex portion (FIG. 3A), the viewing area moves to the left side when the parallax images are shifted to the right side and displayed (FIG. 3B). On the contrary, the viewing area moves to the right side when the parallax images are shifted to the left side and displayed.

Further, the viewing area moves in a direction approaching the liquid crystal panel 1 when the parallax image is not shifted near the center in the horizontal direction and the parallax image is shifted outward to a larger degree on the more external side of the liquid crystal panel 1 (FIG. 3C). It is to be noted that pixels between the shifted parallax image and the non-shifted parallax image, or pixels between the parallax images shifted by different amount, may be interpolated as appropriate according to peripheral pixels. Further, as opposed to FIG. 3C, the viewing area moves in a direction away from the liquid crystal panel 1 when the parallax image is not shifted near the center in the horizontal direction and the parallax image is shifted to the center side to a larger degree on the more external side of the liquid crystal panel 1.

As thus described, by shifting and displaying the whole or part of the parallax images, the viewing area moves in a horizontal or front-back direction with respect to the liquid crystal panel 1. In FIG. 3, only one viewing area is shown for the sake of simplifying the description, but in practice, a plurality of viewing areas are present and these move in conjunction with one another. The viewing area is controlled by the controller 10 in FIG. 2 which will be described later. It should be noted that viewing regions other than the viewing area 21 are reverse view regions in which it is difficult to view good autostereoscopic videos.

Returning to FIG. 1, the camera 3 is installed near the lower center of the liquid crystal panel 1 at a predetermined elevation angle, and photographs video of the front of the liquid crystal panel 1 in a predetermined range. The photographed video is provided to the controller 10 and used for detecting information on the viewer, such as a position of the viewer, a face of the viewer, and the like. The camera 3 may take either a motion image or a still image.

The light receiver 4 is, for example, provided on the lower left side of the liquid crystal panel 1. Then, the light receiver 4 receives an infrared signal transmitted from a remote controller used by the viewer. This infrared signal includes a signal indicative of whether stereoscopic video is displayed or two-dimensional video is displayed, whether the multi-parallax system is taken or the two-parallax system is taken in the case of displaying the stereoscopic video, whether or not to control the viewing area, or the like.

Next, a detail of configuration components of the controller 10 will be described. As shown in FIG. 2, the controller 10 (video processing apparatus) has a tuner decoder 11, a parallax image converter 12, a viewer detector 13, a viewing area information calculator 14, and an image adjuster 15. The controller 10 is implemented, for example, as one IC (Integrated Circuit) and arranged on the back side of the liquid crystal panel 1. Naturally, part of the controller 10 may be implemented by software.

The tuner decoder (receiver) 11 receives an input broadcast wave, tunes (selects a channel), and decodes a coded video signal. In a case where a data broadcasting signal such as an electronic program guide (EPG) is superimposed on the broadcast wave, the tuner decoder 11 extracts this signal. Alternatively, it is also possible that the tuner decoder 11 receives not a broadcast wave but a coded video signal from video output equipment such as an optical disk reproducing apparatus or a personal computer, and decodes this signal. The decoded signal is also referred to as a baseband video signal, and provided to the parallax image converter 12. It should be noted that in the case of the video display apparatus 100 not receiving a broadcast wave but exclusively displaying a video signal received from the image output equipment, a decoder having a decoding function may be simply provided in place of the tuner decoder 11.

The video signal received by the tuner decoder 11 may be a two-dimensional video signal or may be a three-dimensional video signal including images for a left eye and a right eye in a frame packing (FP) format, a side-by-side (SBS) format, a top-and-bottom (TAB) format, or the like. Further, the video signal may be a three-dimensional video signal including images of equal to or more than three parallaxes.

In order to display stereoscopic video, the parallax image converter 12 converts a baseband video signal to a plurality of parallax image signals and provide them to the image adjuster 15. A processing of the parallax image converter 12 varies depending on which system, the multi-parallax system or the two-parallax system, is adopted. Further, the processing of the parallax image converter 12 also varies depending on whether the baseband video signal is a two-dimensional video signal or a three-dimensional video signal.

In the case of adopting the two-parallax system, the parallax image converter 12 generates parallax image signals for a left eye and a right eye corresponding to parallax images for a left eye and a right eye, respectively. More specifically, the following will be performed.

When the two-parallax system is adopted and a three-dimensional video signal including images for a left eye and a right eye is input, the parallax image converter 12 generates parallax image signals for a left eye and a right eye in a format which can be displayed on the liquid crystal panel 1. Further, when a three-dimensional video signal including equal to or more than three images is input, the parallax image converter 12, for example, uses arbitrary two images among them to generate parallax image signals for a left eye and a right eye.

As opposed to this, in a case where the two-parallax system is adopted and a two-dimensional video signal including no parallax information is input, the parallax image converter 12 generates parallax images for a left eye and a right eye based on a depth value of each pixel in the video signal. The depth value is a value indicating that to what extent each pixel is displayed so as to be viewed in front of or in the back of the liquid crystal panel 1. The depth value may be previously added to a video signal, or may be generated by performing motion detection, identification of a composition, detection of a human's face, or the like. In the parallax image for a left eye, a pixel viewed in front needs to be shifted to the right side of a pixel viewed in the back, and to be displayed. For this reason, the parallax image converter 12 performs processing of shifting the pixel viewed in front to the right side in the video signal, to generate a parallax image signal for a left eye. The larger the depth value is, the larger the shift amount is.

Meanwhile, in the case of adopting the multi-parallax system, the parallax image converter 12 generates first to ninth parallax image signals corresponding to first to ninth parallax images, respectively. More specifically, the following will be performed.

When the multi-parallax system is adopted and a two-dimensional video signal or a three-dimensional video signal including less than nine parallaxes is input, the parallax image converter 12 generates first to ninth parallax image signals based on depth information similar to generating parallax image signals for a left eye and a right eye from a two-dimensional video signal.

When the multi-parallax system is adopted and a three-dimensional video signal including nine parallaxes is input, the parallax image converter 12 generates first to ninth parallax image signals using the video signal.

The viewer detector 13 detects the viewer by using the video taken by the camera 3, and recognizes information about the viewer (for example, the number of the viewers, the position of the viewer, face information and so on. Hereinafter, they are collectively referred to as “viewer reorganization information”). Furthermore, the viewer detector 13 can also follow the viewer even if the viewer moves. Therefore, the viewer detector 13 can grasp the viewing time of each viewer.

The position information of the viewer is represented, for example, as a position on an X-axis (horizontal direction), a Y-axis (vertical direction) and a Z-axis (orthogonal direction to the liquid crystal panel 1) with the center of the liquid crystal panel 1 regarded as an original point. More specifically, the viewer detector 13 first detects a face from the video taken by the camera 3, to recognize the viewer. Subsequently, the viewer detector 13 detects positions on the X-axis and the Y-axis from the position of the viewer in the video, and detects a position on the Z-axis from a size of the face. The number of the viewers can be obtained from the number of the detected faces of the viewers. When a plurality of viewers is present, the viewer detector 13 may detect positions of the predetermined number (e.g., ten) of viewers. In this case, when the number of detected faces is larger than ten, for example, positions of ten viewers are detected in an increasing order of a distance from the liquid crystal panel 1, namely an increasing order of the position on the Z-axis.

The technique for detecting the viewer's position by the viewer detector 13 is not particularly restricted. The camera 3 may be an infrared camera, and the viewer's position may be detected by a sound wave.

The viewing area information calculator 14 calculates a control parameter for setting the viewing area according to the number of the viewer and the position thereof. The control parameter includes, for example, a shift length of a parallax image described in FIG. 3, and is one parameter or a combination of multiple parameters. The viewing area information calculator 14 provides the calculated control parameter to the image adjuster 15.

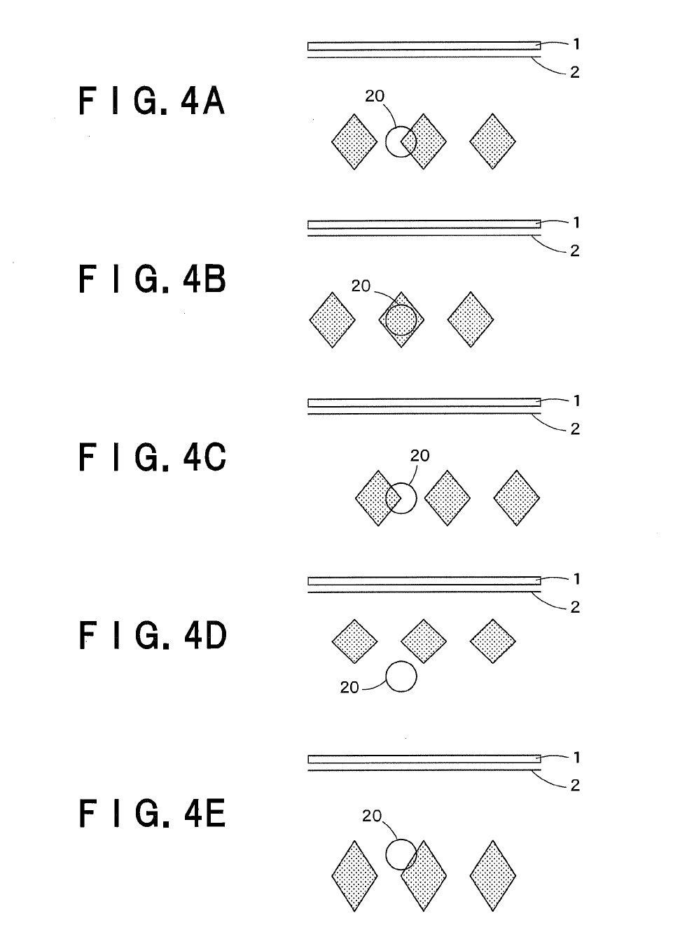

FIG. 4 is a view showing an example of the technique for calculating viewing area information. The viewing area information calculator 14 previously defines several settable patterns of viewing area. Then, the viewing area information calculator 14 calculates an overlapping area between the viewing area and the detected viewer, and determines a viewing area with the calculated area being maximal as an appropriate viewing area. In the example of FIG. 4, an overlapping area between a viewer 20 and the viewing area is maximal in FIG. 4B where the viewing area is set on the left side with respect to the liquid crystal panel 1 among five patterns of viewing area (shaded areas) in FIGS. 4A to 4E which have been previously defined. Therefore, the viewing area information calculator 14 determines the pattern of viewing area in FIG. 4B as an appropriate viewing area. In this case, a control parameter for displaying the parallax image in the pattern in FIG. 4B is provided to the image adjuster 15 in FIG. 2.

More specifically, in order to set a desired viewing area, the viewing area information calculator 14 may use a viewing area database associating the control parameter with a viewing area set by that control parameter. The viewing area information calculator 14 can find a viewing area capable of keeping the selected viewers by searching the viewing area database.

For controlling the viewing area, the image adjuster (viewing area controller) 15 performs adjustment such as shift or interpolation of a parallax image signal according to the calculated control parameter, and provides the adjusted signal to the liquid crystal panel 1. The liquid crystal panel 1 displays an image corresponding to the adjusted parallax image signal.

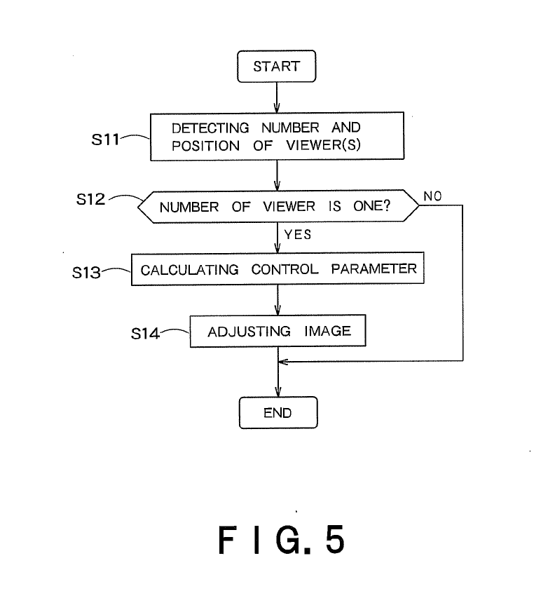

FIG. 5 is a flowchart showing an example of processing operations of the controller 10 of the video display apparatus 100 according to the first embodiment.

First, the viewer detector 13 detects the number of viewers and their positions by using the video taken by the camera 3 (Step S11). Then, the viewing area is set as follows according to the detected number of viewers and their positions.

When the number of viewers is one (Step S12: YES), the viewing area information calculator 14 calculates a control parameter such that the viewing area is set at the position of the viewer (Step S13). Then, the image adjuster 15 adjusts parallax image signals according to the control parameter (Step S14), and parallax images corresponding to the adjusted parallax image signals are displayed on the liquid crystal panel 1. By such a manner, the viewing area is appropriately set.

On the other hand, when the number of viewers is more than one (Step S12: NO), the viewing area information calculator 14 does not update the control parameter so as not to change the viewing area and as to keep the current viewing area. As a result, the processing on the image adjuster 15 is not updated either, and thus, the viewing area is kept in a fixed position.

For example, in a case where one person out of a plurality of persons moves while they are viewing video, if the viewing area followed the person having moved, viewing states of the other viewers who stay still and view the video might deteriorate. As opposed to this, in the present embodiment, the viewing area is kept fixed, and hence an appropriate viewing area is set for the viewers staying still and viewing the video.

As described above, in the first embodiment, the number of viewers is detected, and when the number of viewers is one, a viewing area appropriate for that viewer is set, and hence a viewing area appropriate for the viewer is set. On the other hand, since the viewing area is not updated when the number of viewers is more than one, an unnecessary change in viewing area can be suppressed when there is a plurality of viewers.

### Second Embodiment

The foregoing first embodiment was one in which the viewing area is not updated when the number of viewers is more than one. As opposed to this, a second embodiment is one in which the viewing area is updated based on a predetermined priority setting rule.

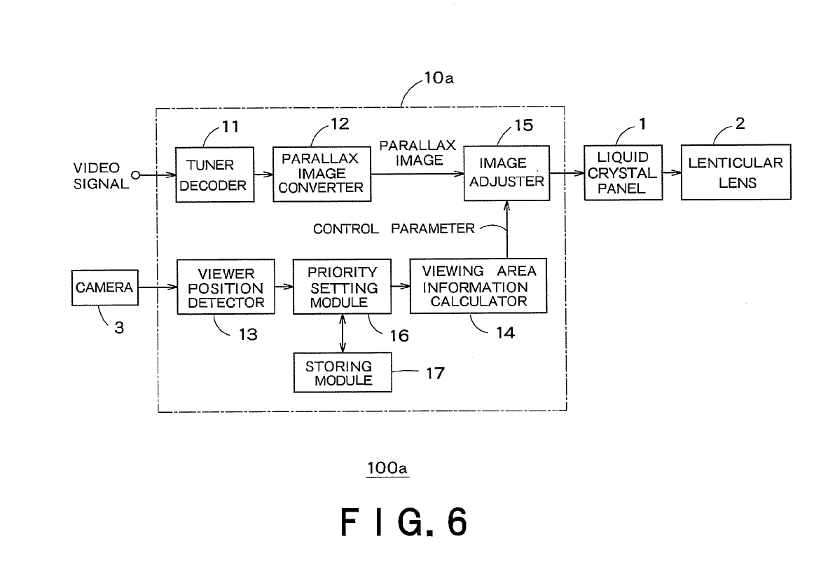

FIG. 6 is a block diagram showing a schematic configuration of a video display apparatus 100a according to the second embodiment. In FIG. 6, constitutional portions in common with those in FIG. 2 are provided with the same numerals, and hereinafter, a description will be made with a focus on a difference.

A controller 10a of the video display apparatus 100a in FIG. 6 further has a priority setting module 16 and a storing module 17. When the number of viewers is more than one, the priority setting module 16 sets a priority on each viewer based on the predetermined priority setting rule. Examples of the priority rule will be described later. The storing module 17 is used for setting a priority.

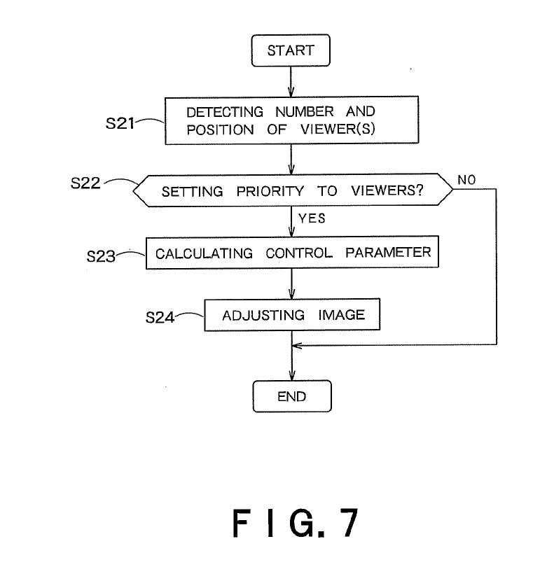

FIG. 7 is a flowchart showing an example of processing operations of the controller 10a of the video display apparatus 100a according to the second embodiment.

First, the viewer detector 13 detects the number of viewers and their positions by using video taken by the camera 3 (Step S21). Then, the priority setting module 16 sets a priority on each viewer (Step S22). When the number of viewers is one, the priority setting module 16 may set the highest priority on that viewer. On the other hand, when the number of viewers is more than one, the priority setting module 16 sets a priority on each viewer based on the priority setting rule. The priority and position of each viewer are supplied to the viewing area information calculator 14.

Subsequently, the viewing area information calculator 14 calculates a control parameter according to the priorities (Step S23). For example, the viewing area information calculator 14 calculates a control parameter such that the viewing area is set at a position of a viewer with the highest priority. Alternatively, the viewing area information calculator 14 may calculate a control parameter such that the largest possible number of viewers are held in the viewing area in descending order of priority. That is, first, the viewing area information calculator 14 tries to calculate the control parameter so that all of the viewers except a viewer having the lowest priority are within the viewing area. When a control parameter is still not calculated, the viewing area information calculator 14 further tries to calculate the control parameter so that remaining viewers except a viewer having the lowest priority among the remaining viewers are within the viewing area. By repeatedly performing this, it is possible to calculate a control parameter for preferentially holding viewers with relatively high priorities within the viewing area.

The image adjuster 15 then adjusts the parallax image signals according to the control parameter calculated as thus described (Step S24), and parallax images corresponding to the adjusted parallax image signals are displayed on the liquid crystal panel 1.

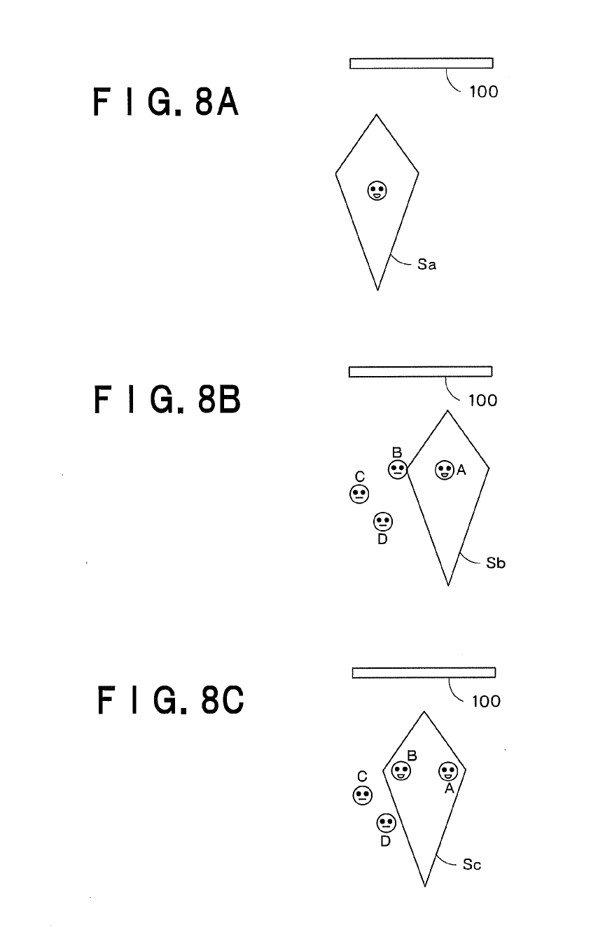

FIG. 8 is a view showing a specific example of viewing area setting according to the present embodiment.

FIG. 8A shows an example of a case where the number of viewers is one. When the number of viewers is one, a viewing area Sa is set in a position of that viewer.

FIGS. 8B to 8C show examples of the case where the number of viewers is more than one. Both figures show the video display apparatus 100, viewers A to D and set viewing areas Sb, Sc, and the number of viewers and their positions are the same. Further, it is assumed that priorities of the respective viewers descend in the order of the viewers A, B, C, D.

FIG. 8B is an example where the viewing area information calculator 14 calculates a control parameter such that the viewing area is set at the position of the viewer with the highest priority in Step S23. In this case, in order to allow the viewer A with the highest priority to view video of the highest quality, the viewing area is set such that a position of the viewer A is located at the center of the viewing area. The viewers with the second highest or lower priorities are not considered.

FIG. 8C is an example where the viewing area information calculator 14 calculates a control parameter such that the largest possible number of viewers is held in the viewing area in descending order of priority in Step S23. In this case, although the viewer A with the highest priority is out of the center of the viewing area, for example, the two viewers A, B with relatively high priorities can be held in the viewing area.

Hereinafter, the priority setting rule will be described.

As a first example, priorities can be set to the viewers in descending order of viewing time. This is because the viewer whose viewing time for a program is longer is likely to have higher eagerness to view the program. As for the viewing time, for example, a start time of contents is taken as a reference. In the case of viewing a program transmitted by a broadcast wave, for example, the start time of contents can be grasped from information of an electronic program guide acquired by the tuner decoder 11. Further, the viewing time may be stored into the storing module 17.

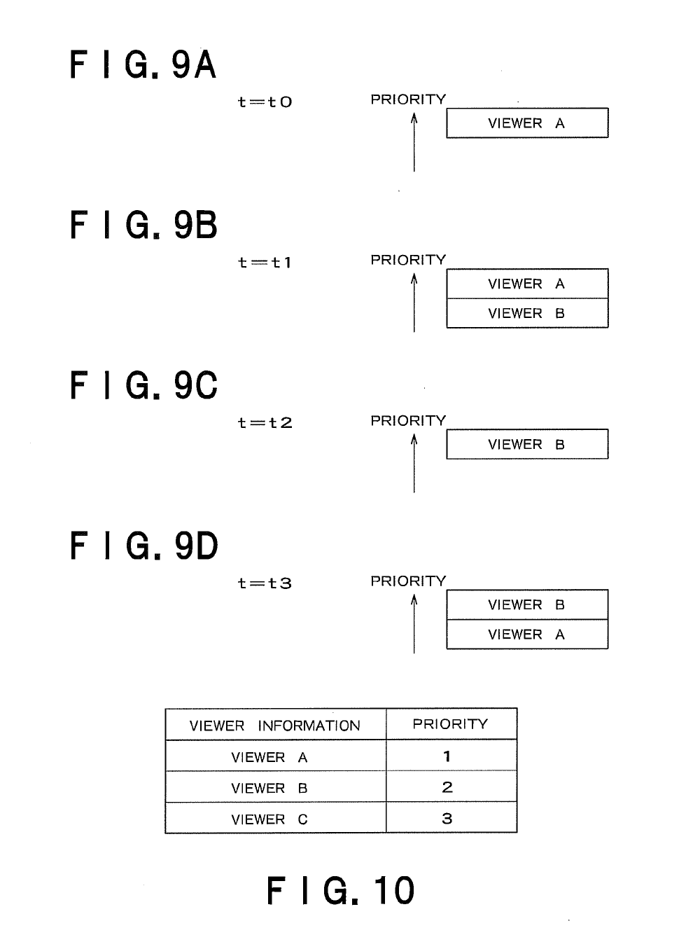

FIG. 9 is a view explaining an example where priorities are set based on viewing time. In the figure, a viewer with higher priority is drawn in an upper position.

First, when only the viewer A is viewing video and detected by the viewer detector 13 at a time t0, a priority of the viewer A is set the highest (FIG. 9A). When the viewer B is newly detected by the viewer detector 13 at a time t1, a priority of the viewer B is set lower than that of the viewer A (FIG. 9B) since the viewing time of the viewer A is longer. When the viewer A moves away and comes not to be detected by the viewer detector 13 at a time t2, the priority of the viewer B is set higher (FIG. 9C). At this time, the viewing time of the viewer A stored in the storing module 17 is reset to 0. Even when the viewer A gets back and is again detected by the viewer detector 13 at a time t3, the priority of the viewer A is set lower than that of the viewer B (FIG. 9D) since the viewing time of the viewer B is longer.

It is to be noted that the viewing time may not be reset to 0 in the case of the time when the viewer is not detected by the viewer detector 13 is short.

As a second example, a priority table indicating the relationship between information of viewers and priorities may be stored in the storing module 17 in advance. The information of viewers is, for example, faces of viewers. Then, the viewer detector 13 can detect faces of viewers by using video taken by the camera 3, and the priority setting module 16 can set a priority on each viewer by means of the priority table stored in the storing module 17.

FIG. 10 is a view showing an example of the priority table. In the figure, priorities are set higher in the order of the viewers A, B, C in advance. The viewers A to C are, for example, families. The viewer A is a mother, the viewer B is a child, and a viewer C is a father. It should be noted that as viewer information, faces or the like of the viewers A to C are registered in practice.

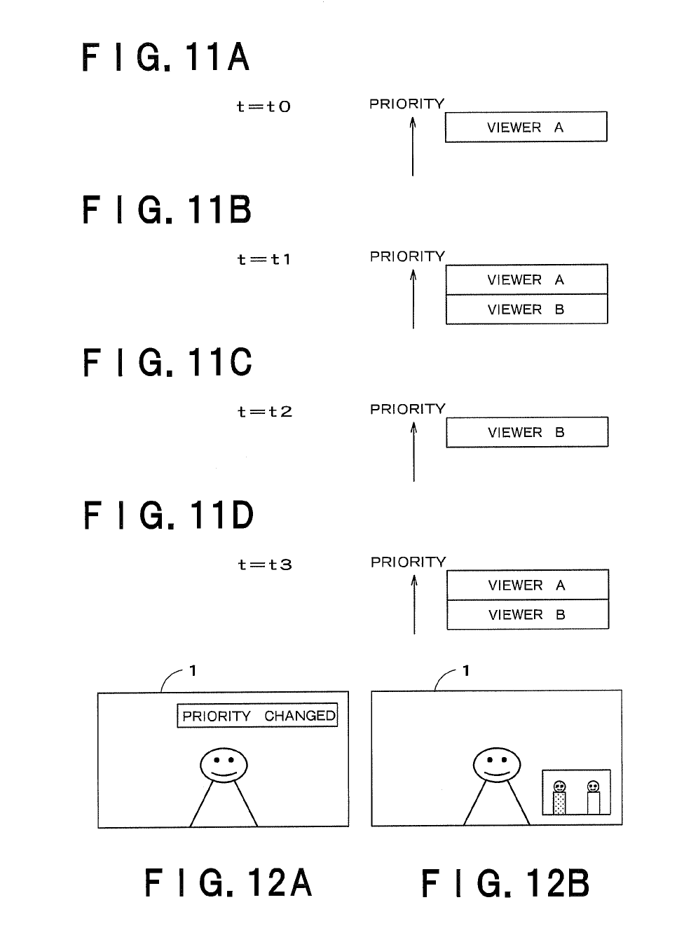

FIG. 11 is a view showing the example where priorities are set based on the priority table. First, when only the viewer A is viewing video and detected by the viewer detector 13 at a time t0, a priority of the viewer A is set the highest (FIG. 11A). When the viewer B is newly detected by the viewer detector 13 at a time t1, a priority of the viewer B is set lower than that of the viewer A (FIG. 11B) since the priority of the viewer A is higher (FIG. 10). When the viewer A moves away and comes not to be detected by the viewer detector 13 at a time t2, the priority of the viewer B is set higher (FIG. 11C). When the viewer A gets back and is again detected by the viewer detector 13 at a time t3, the priority of the viewer B is set lower than that of the viewer A (FIG. 11D) regardless of the viewing time since the priority of the viewer A is higher (FIG. 10).

As another example, the priority setting module 16 may set a priority according to the viewer's position. For example, a higher priority may be set on a viewer being in a position closer to 3H (H is a height of the liquid crystal panel 1) which is an optimal viewing distance, or a higher priority may be set on a viewer closer to the liquid crystal panel 1. Alternatively, a higher priority may be set on a viewer being in front of the liquid crystal panel 1. Moreover, the highest priority may be set on a viewer having a remote controller.

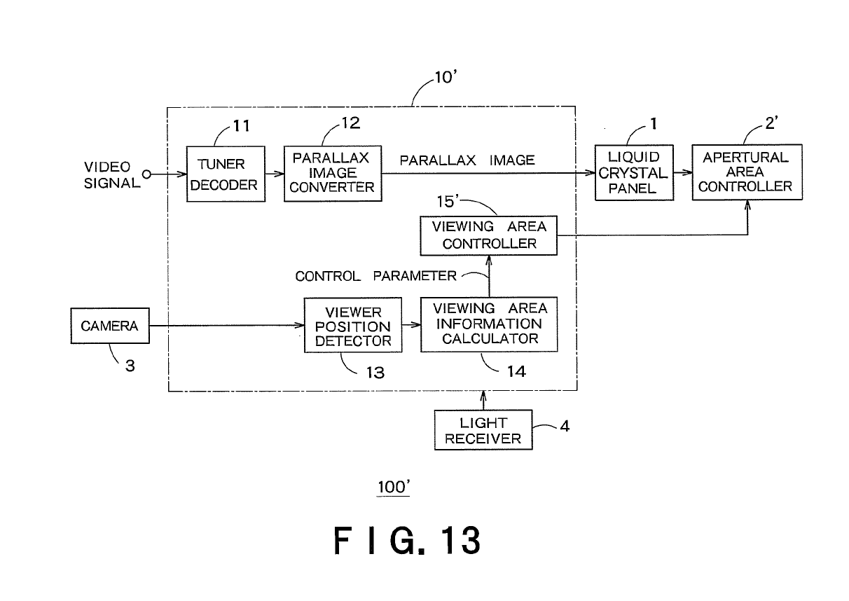

Incidentally, the priority setting module 16 may show the relationship between a viewer and a priority of that viewer. For example, as shown in FIG. 12A, when a priority on a viewer is changed, text data indicating as such may be superimposed on video and displayed on the liquid crystal panel 1. Further, as shown in FIG. 12B, a whole or part of video captured by the camera 3 may be displayed on the liquid crystal panel 1 while display configuration of viewers are varied according to priorities thereof. More specifically, a color of a viewer with a higher priority may be made darker, or a color tone may be varied according to the priority. Alternatively, markers (flags) may be added to a predetermined number of viewers in descending order of priority, and displayed.

As described above, in the second embodiment, since priorities are placed on viewers and then a viewing area is set, even when a plurality of viewers are present and part of the viewers cannot be held within the viewing area, viewers with high priorities can be held within the viewing area.

In addition, although, in each of the embodiments, examples of the video display apparatus were shown where a viewing area is controlled by using the lenticular lens2 and shifting the parallax images, the viewing area may be controlled by another technique. For example, a parallax barrier may be provided as the apertural area controller in place of the lenticular lens 2. Further, FIG. 13 is a block diagram showing a schematic configuration of a video display apparatus 100′ as a modification of FIG. 2. As shown in the figure, the processing of shifting the parallax image may not be performed, and a viewing area controller 15′ may be provided inside a controller 10′, to control an apertural area controller 2′. In this case, the distance between the liquid crystal panel 1 and the apertural area controller 2′, a horizontal shift length between the liquid crystal panel 1 and the apertural controller 2′, or the like is regarded as a control parameter, and an output direction of a parallax image displayed on the liquid crystal panel 1 is controlled, thereby controlling the viewing area. The video display apparatus in FIG. 13 may be applied to each of the embodiments.

At least a part of the video processing apparatus explained in the above embodiments can be formed of hardware or software. When the video processing apparatus is partially formed of the software, it is possible to store a program implementing at least a partial function of the video processing apparatus in a recording medium such as a flexible disc, CD-ROM, etc. and to execute the program by making a computer read the program. The recording medium is not limited to a removable medium such as a magnetic disk, optical disk, etc., and can be a fixed-type recording medium such as a hard disk device, memory, etc.

Further, a program realizing at least a partial function of the video processing apparatus can be distributed through a communication line (including radio communication) such as the Internet etc. Furthermore, the program which is encrypted, modulated, or compressed can be distributed through a wired line or a radio link such as the Internet etc. or through the recording medium storing the program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A video processing apparatus comprising:
a viewer detector configured to detect a number and a position of one or more viewers based on an image; and
a controller configured to set a viewing area at the position of the viewer when the number of viewers is one, and to maintain a present viewing area when the number of viewers is more than one,
wherein a plurality of parallax images displayed on a display are configured to be viewed as a stereoscopic image in the viewing area.

2-11. (canceled)

12. The apparatus of claim 1, wherein the controller is configured to:
adjust a display position of the plurality of parallax images displayed on the display; or
control an output direction of the plurality of parallax images displayed on the display.

13. The apparatus of claim 1, further comprising:
a display configured to display the plurality of parallax images; and
an apertural area controller configured to output the plurality of parallax images displayed on the display toward a first direction.

14. The apparatus of claim 1, further comprising:
a receiver configured to decode an input video signal; and
a parallax image converter configured to generate the plurality of parallax images based on the decoded input video signal.

15. The apparatus of claim 14, wherein the receiver is configured to receive and tune a broadcast wave, and to decode the tuned broadcast wave.

16. The apparatus of claim 1, further comprising a camera configured to obtain a video to detect the number and the position of one or more viewers.

17. A video processing method, comprising:
detecting a number and a position of one or more viewers based on an image; and
setting a viewing area at the position of the viewer when the number of viewers is one, and to maintain a present viewing area when the number of viewers is more than one,
wherein a plurality of parallax images displayed on a display are configured to be viewed as a stereoscopic image in the viewing area.

18-20. (canceled)

21. The apparatus of claim 1, wherein the controller is configured to maintain the present viewing area when the number of viewers is more than one and even when part of the viewers moves.

22. The method of claim 17, wherein the present viewing area is maintained when the number of viewers is more than one and even when part of the viewers moves.
